(19) United States
(12) Patent Application Publication
(10) Pub. No.: US 2026/0241218 A1
(43) Pub. Date: Aug. 20, 2026

(54) COMBINED CONDENSED AEROSOL FIRE-EXTINGUISHING AGENT AND PREPARATION METHOD THEREFOR

(71) Applicant: HUBEI JIANDUN FIRE TECHNOLOGY CO., LTD., Yichang (CN)

(72) Inventors: Xinyu LIU, Yichang (CN); Fagui LU, Yichang (CN); Rui HUANG, Yichang (CN); Beibei ZOU, Yichang (CN); Lili ZHENG, Yichang (CN)

(73) Assignee: HUBEI JIANDUN FIRE TECHNOLOGY CO., LTD., Yichang, HB (CN)

(21) Appl. No.: 19/164,214

(22) PCT Filed: Apr. 28, 2023
(86) PCT No.: PCT/CN2023/091579

§ 371 Date: Sep. 11, 2025

(30) Foreign Application Priority Data
Mar. 16, 2023 (CN) 202310255936.8

(51) Int. Cl. A62D 1/06

(52) U.S. Cl. CPC A62D 1/06

(57) ABSTRACT

Disclosed in the present invention are a combined condensed aerosol fire-extinguishing agent and a preparation method therefor. The method includes preparing a fast-acting agent and a slow-acting agent respectively by mixing an oxidizing agent, a reducing agent, a binder and a burning rate regulator in certain proportions; then performing separate pressing; and next, placing the fast-acting agent and the slow-acting agent successively into an agent pressing mold, dropwise adding anhydrous ethanol to a contact surface between the two agents, and pressing while heating to obtain a combined condensed aerosol fire-extinguishing agent. The combined condensed aerosol fire-extinguishing agent has the advantages of a low fire-extinguishing concentration and a fast fire-extinguishing speed, which reduces the amount of the fire-extinguishing agent, lowers the use cost, and also alleviates the impact of products after fire extinguishment on people and ecological environments.

### TECHNICAL FIELD

The present invention relates to the technical field of fire extinguishing, and particularly to a combined condensed aerosol fire-extinguishing agent and a preparation method therefor.

### BACKGROUND OF THE INVENTION

At present, condensed aerosol fire-extinguishing agents have been extensively studied and applied due to their high extinguishing efficiency, non-toxicity, no damage to the ozone layer, and storage at normal pressure. Condensed aerosol fire-extinguishing agents mainly extinguish fires by means of the principle of chemical inhibition. The solid particles in the composition thereof can decompose into metal ions that can consume free radicals (such as H, HO, and O), which are intermediate products of combustion reactions, thereby achieving the effects of blocking combustion and suppressing fires. At the same time, the gas components in condensed aerosol fire-extinguishing agents can also inhibit fires to a certain extent by diluting the concentration of combustible gases and oxygen in the protected space. Most of the existing condensed aerosol fire-extinguishing agents suppress fires by filling the entire protected space with aerosols, and this fire-extinguishing method is called total flooding extinguishing. The total flooding extinguishing of condensed aerosols has a wide range of applications, which currently involve aircraft fuel tanks, ship engines, archives, libraries, cargo hold control rooms, petroleum product storage tanks, liquefied gas storage tanks, power distribution rooms, generator rooms, and other places. In addition, some aerosol fire-extinguishing devices are installed with consideration of the combined application of fixed-point extinguishing and total flooding extinguishing methods, but due to the limitation of a single agent, they all show limited fire-extinguishing capacity.

Chinese Patent CN105597259 discloses a rapid and efficient aerosol fire-extinguishing agent and a preparation method therefor, which uses an oxidizing agent, a combustible agent, a modifying agent and a binder to prepare an aerosol fire-extinguishing agent that burns rapidly and can generate a large number of fire-extinguishing substances in a short time. Chinese Patent CN102179024B discloses a fire-extinguishing composition for generating a fire-extinguishing substance through a chemical reaction among components at high temperature, including 50%-90% of a flame retardants, 5%-30% of an oxidizing agent, 5%-10% of a reducing agent and 0%-10% of a binder. Smoke and fire agents are taken as a heat source and power source, and by utilizing the high temperature generated through combustion of the smoke and fire agents, the fire-extinguishing composition reacts to generate an active fire-extinguishing substance for extinguishing fires, which is more efficient and safer compared with traditional aerosol generating agents. Studies by Zhao Yu et al. have shown that when the ratio of Sr(NO₃)₂ to KNO₃ in the aerosol fire-extinguishing agent is in the range of 1.4-5.0, the effect is optimal, with a fire-extinguishing efficiency of 95 g/m³, an ejection time of 42 seconds, and no obvious greening of the copper plate. This not only ensures the fire-extinguishing capability of the aerosol but also effectively solves the corrosion problem (Zhao Yu, Chen Bin, Huang Yinsheng, et al. Study on Formulation and Optimization Design of Aerosol Fire-Extinguishing Agents. Blasting Equipment, 2012).

However, current aerosol fire-extinguishing agents all adopt a single formulation. For long-distance fixed-point extinguishing, the content of the oxidizing agent in the formulation is increased while the content of the reducing agent is decreased, thereby preparing an aerosol fire-extinguishing agent with fast release speed, high discharge intensity, and low gas production. When total flooding extinguishing is required in a protected space, the formulation is adjusted to reduce the release speed and discharge intensity of the aerosol fire-extinguishing agent while increasing gas production. In practical applications, however, it has been found that regardless of the formulation for the aerosol fire-extinguishing agent, total flooding extinguishing is involved in the fire-extinguishing process. In such cases, aerosol fire-extinguishing agents with low gas production exhibit low fire-extinguishing efficiency, while those with high gas production have high fire-extinguishing concentrations and long fire-extinguishing times, and are prone to causing secondary disasters.

### SUMMARY OF THE INVENTION

To solve the above-mentioned technical problems, an objective of the present invention is to provide a combined condensed aerosol fire-extinguishing agent and a preparation method therefor. The fire-extinguishing agent is prepared by combining a fast-acting agent and a slow-acting agent, so as to extinguish fires at a low concentration in a short time. The fast-acting agent is defined as an agent with a burning rate greater than 3.0 mm/s when the cartridge density is 1.6 g/cm3, and the slow-acting agent is defined as an agent with a burning rate less than 2.0 mm/s when the cartridge density is 1.6 g/cm3.

The present invention adopts the following technical solutions:

The present invention provides a combined condensed aerosol fire-extinguishing agent, comprising a fast-acting fire-extinguishing agent and a slow-acting fire-extinguishing agent.

Preferably, the fast-acting fire-extinguishing agent comprises 60-78 parts of an oxidizing agent, 10-30 parts of a reducing agent, 10-12 parts of a binder, and 0-10 parts of a catalyst; and the slow-acting fire-extinguishing agent comprises 60-78 parts of an oxidizing agent, 10-30 parts of a reducing agent, 10-12 parts of a binder, and 0-10 parts of a retardant.

Preferably, the oxidizing agent is any one of potassium nitrate, sodium nitrate, strontium nitrate and barium nitrate; the reducing agent is any one of dicyandiamide, nitroguanidine, activated carbon and melamine; the binder is any one of phenolic resin and carboxymethyl cellulose; the catalyst is any one of copper oxide, iron oxide and tert-butylferrocene; and the retardant is any one of calcium carbonate, magnesium oxide and potassium chloride.

Preferably, a mass ratio of the fast-acting fire-extinguishing agent to the slow-acting fire-extinguishing agent is 1-9:9-1.

The present invention further provides a preparation method for a combined condensed aerosol fire-extinguishing agent, comprising the following steps:
(1) dissolving a binder in anhydrous ethanol and mixing well to obtain a binder solution;
(2) sieving an oxidizing agent, a reducing agent and a catalyst and mixing well, then adding the binder solution, and drying to obtain a fast-acting agent;
(3) sieving the oxidizing agent, the reducing agent and a retardant and mixing well, then adding the binder solution, and drying to obtain a slow-acting agent;
(4) pressing the fast-acting agent and the slow-acting agent into cartridges, respectively; and
(5) placing the slow-acting agent cartridge and the fast-acting agent cartridge successively into an agent pressing mold, dropwise adding the anhydrous ethanol between the two agents, and pressing while heating to prepare a fire-extinguishing agent.

Preferably, in step (1), a mass of the anhydrous ethanol is 5-6% of a total mass of the fire-extinguishing agent.

Preferably, in step (4), a pressing pressure is 3-4 MPa.

Preferably, in step (5), a heating temperature is 25-30° C., and a pressing pressure is 8-10 MPa.

Preferably, in step (5), a mass of the anhydrous ethanol is 2-8% of the total mass of the fire-extinguishing agent.

The present invention has the following advantages: the present invention uses a combination of the fast-acting agent and the slow-acting agent, combines the advantages of the fast-acting agent and the slow-acting agent, reduces the concentration of the fire-extinguishing agent, shortens the fire-extinguishing time, reduces the amount of the fire-extinguishing agent, and reduces the cost. In addition, the fire-extinguishing agent used in the present invention does not produce contaminants after combustion and injection, thereby greatly reducing the impact on people and the environment.

In the present invention, the fast-acting agent and the slow-acting agent are respectively pressed and molded, and the anhydrous ethanol is added dropwise onto a contact surface of the two agents for bonding, and a method of pressing while heating is used to prevent mutual permeation of the two agents during the preparation process of the combined fire-extinguishing agent, which would otherwise affect the fire-extinguishing effect. At the same time, problems such as breakage, aging and failure of the combined fire-extinguishing agent during transportation can be avoided. In addition, the anhydrous ethanol can dissolve the binder to enhance the bonding effect on the combined fire-extinguishing agent. Meanwhile, the anhydrous ethanol volatilizes during the subsequent heating and pressing process, which prevents the excess anhydrous ethanol on the contact surface of the cartridges from volatilizing again after the preparation of the fire-extinguishing agent to form small air bubbles, which would lead to uneven combustion of the agent and affect the fire-extinguishing effect.

### BRIEF DESCRIPTION OF DRAWINGS

FIG. 1 is a line graph showing the content of the fast-acting agent and the fire-extinguishing concentration in the fire-extinguishing agent prepared in different examples.

FIG. 2 is a line graph showing the content of the fast-acting agent in the fire-extinguishing agent and the fire-extinguishing time prepared in different examples.

### DETAILED DESCRIPTION OF EMBODIMENTS

In the following examples, the fast-acting agent is defined as an agent with a burning rate greater than 3.0 mm/s when the cartridge density is 1.6 g/cm³, and the slow-acting agent is defined as an agent with a burning rate less than 2.0 mm/s when the cartridge density is 1.6 g/cm³.

The present invention is described in further detail below in conjunction with the specific embodiments, and the technical solution of the present invention will thus become clearer. It should be noted that the following examples are only preferred embodiments of the present invention and should not be construed as limiting the present invention. The scope of protection of the present invention shall be subject to the content recorded in the claims. Modifications and equivalent substitutions made to the technical solution of the present invention by those skilled in the art without making creative work shall all fall within the scope of protection of the present invention.

### Example 1

(1) Prepare a binder solution: add 12 parts of phenolic resin to 6 parts of anhydrous ethanol for dissolution, and stir evenly to obtain a binder solution;
(2) Prepare a fast-acting agent: take 60 parts of potassium nitrate, 28 parts of dicyandiamide, and 10 parts of copper oxide, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 60 parts of potassium nitrate, 28 parts of dicyandiamide, and 1 part of calcium carbonate, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 90 parts of the fast-acting agent and 10 parts of the slow-acting agent, and press the agents under a pressure of 4 MPa respectively to form a fast-acting agent cartridge and a slow-acting agent cartridge; and
(5) Place the fast-acting agent cartridge in an agent pressing mold, drop the anhydrous ethanol onto a surface of the fast-acting agent cartridge, then quickly place the slow-acting agent cartridge on top of the fast-acting agent cartridge, simultaneously, maintain a temperature of an agent pressing instrument at 28° C., adjust the pressure to 8 MPa for pressing, and prepare a cylindrical fire-extinguishing agent with a diameter of Φ64 mm, where an amount of the anhydrous ethanol is 5% of a total mass of the fire-extinguishing agent, and a content of the anhydrous ethanol after pressing is less than 1%.

### Example 2

(1) Prepare a binder solution: add 12 parts of phenolic resin to 6 parts of anhydrous ethanol for dissolution, and stir evenly to obtain a binder solution;
(2) Prepare a fast-acting agent: take 60 parts of sodium nitrate, 28 parts of dicyandiamide, and 10 parts of copper oxide, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 60 parts of sodium nitrate, 28 parts of dicyandiamide, and 1 part of calcium carbonate, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 70 parts of the fast-acting agent and 30 parts of the slow-acting agent, and press the agents under a pressure of 4 MPa respectively to form a fast-acting agent cartridge and a slow-acting agent cartridge; and
(5) Place the fast-acting agent cartridge in an agent pressing mold, drop the anhydrous ethanol onto a surface of the fast-acting agent cartridge, then quickly place the slow-acting agent cartridge on top of the fast-acting agent cartridge, heat to 28° C., adjust the pressure to 8 MPa for pressing, and prepare a cylindrical fire-extinguishing agent with a diameter of Φ64 mm, where an amount of the anhydrous ethanol is 5% of a total mass of the fire-extinguishing agent, and a content of the anhydrous ethanol after pressing is less than 1%.

### Example 3

(1) Prepare a binder solution: add 12 parts of phenolic resin to 6 parts of anhydrous ethanol for dissolution, and stir evenly to obtain a binder solution;
(2) Prepare a fast-acting agent: take 65 parts of sodium nitrate, 23 parts of nitroguanidine, and 8 parts of copper oxide, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 65 parts of sodium nitrate, 23 parts of nitroguanidine, and 2 parts of magnesium oxide, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 50 parts of the fast-acting agent and 50 parts of the slow-acting agent, and press the agents under a pressure of 4 MPa respectively to form a fast-acting agent cartridge and a slow-acting agent cartridge; and
(5) Place the fast-acting agent cartridge in an agent pressing mold, drop the anhydrous ethanol on a surface of the fast-acting agent cartridge, then quickly place the slow-acting agent cartridge on top of the fast-acting agent cartridge, heat to 28° C., adjust the pressure to 8 MPa for pressing, and prepare a cylindrical fire-extinguishing agent with a diameter of Φ64 mm, where an amount of the anhydrous ethanol is 5% of a total mass of the fire-extinguishing agent, and a content of the anhydrous ethanol after pressing is less than 1%.

### Example 4

(1) Prepare a binder solution: add 12 parts of phenolic resin to 6 parts of anhydrous ethanol for dissolution, and stir evenly to obtain a binder solution;
(2) Prepare a fast-acting agent: take 65 parts of strontium nitrate, 23 parts of nitroguanidine, and 8 parts of copper oxide, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 65 parts of strontium nitrate, 23 parts of nitroguanidine, and 2 parts of magnesium oxide, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 30 parts of the fast-acting agent and 70 parts of the slow-acting agent, and press the agents under a pressure of 4 MPa respectively to form a fast-acting agent cartridge and a slow-acting agent cartridge; and
(5) Place the fast-acting agent cartridge in an agent pressing mold, drop the anhydrous ethanol on a surface of the fast-acting agent cartridge, then quickly place the slow-acting agent cartridge on top of the fast-acting agent cartridge, heat to 28° C., adjust the pressure to 8 MPa for pressing, and prepare a cylindrical fire-extinguishing agent with a diameter of Φ64 mm, where an amount of the anhydrous ethanol is 5% of a total mass of the fire-extinguishing agent, and a content of the anhydrous ethanol after pressing is less than 1%.

### Example 5

(1) Prepare a binder solution: add 12 parts of phenolic resin to 6 parts of anhydrous ethanol for dissolution, and stir evenly to obtain a binder solution;
(2) Prepare a fast-acting agent: take 70 parts of potassium nitrate, 18 parts of activated carbon, and 6 parts of iron oxide, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 70 parts of potassium nitrate, 18 parts of activated carbon, and 3 parts of magnesium oxide, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 10 parts of the fast-acting agent and 90 parts of the slow-acting agent, and press the agents under a pressure of 3 MPa respectively to form a fast-acting agent cartridge and a slow-acting agent cartridge; and
(5) Place the fast-acting agent cartridge in an agent pressing mold, drop the anhydrous ethanol on a surface of the fast-acting agent cartridge, then quickly place the slow-acting agent cartridge on top of the fast-acting agent cartridge, heat to 28° C., adjust the pressure to 9 MPa for pressing, and prepare a cylindrical fire-extinguishing agent with a diameter of Φ64 mm, where an amount of the anhydrous ethanol is 5% of a total mass of the fire-extinguishing agent, and a content of the anhydrous ethanol after pressing is less than 1%.

### Example 6

(1) Prepare a binder solution: add 12 parts of phenolic resin to 5 parts of anhydrous ethanol for dissolution, and stir evenly to obtain a binder solution;
(2) Prepare a fast-acting agent: take 70 parts of barium nitrate, 18 parts of activated carbon, and 6 parts of iron oxide, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 70 parts of barium nitrate, 18 parts of activated carbon, and 3 parts of magnesium oxide, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 10 parts of the fast-acting agent and 90 parts of the slow-acting agent, and press the agents under a pressure of 3 MPa respectively to form a fast-acting agent cartridge and a slow-acting agent cartridge; and
(5) Place the slow-acting agent cartridge in an agent pressing mold, drop the anhydrous ethanol on a surface of the slow-acting agent cartridge, then quickly place the fast-acting agent cartridge on top of the slow-acting agent cartridge, heat to 25° C., adjust the pressure to 9 MPa for pressing, and prepare a cylindrical fire-extinguishing agent with a diameter of Φ64 mm, where an amount of the anhydrous ethanol is 5% of a total mass of the fire-extinguishing agent, and a content of the anhydrous ethanol after pressing is less than 1%.

### Example 7

(1) Prepare a binder solution: add 10 parts of carboxymethyl cellulose to 5 parts of anhydrous ethanol for dissolution, and stir evenly to obtain a binder solution;
(2) Prepare a fast-acting agent: take 75 parts of potassium nitrate, 15 parts of melamine, and 3 parts of iron oxide, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 75 parts of potassium nitrate, 15 parts of melamine, and 6 parts of potassium chloride, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 30 parts of the fast-acting agent and 70 parts of the slow-acting agent, and press the agents under a pressure of 3 MPa respectively to form a fast-acting agent cartridge and a slow-acting agent cartridge; and
(5) Place the slow-acting agent cartridge in an agent pressing mold, drop the anhydrous ethanol on a surface of the slow-acting agent cartridge, then quickly place the fast-acting agent cartridge on top of the slow-acting agent cartridge, heat to 25° C., adjust the pressure to 9 MPa for pressing, and prepare a cylindrical fire-extinguishing agent with a diameter of Φ64 mm, where an amount of the anhydrous ethanol is 5% of a total mass of the fire-extinguishing agent, and a content of the anhydrous ethanol after pressing is less than 1%.

### Example 8

(1) Prepare a binder solution: add 10 parts of carboxymethyl cellulose to 5 parts of anhydrous ethanol for dissolution, and stir evenly to obtain a binder solution;
(2) Prepare a fast-acting agent: take 75 parts of strontium nitrate, 15 parts of melamine, and 3 parts of iron oxide, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 75 parts of strontium nitrate, 15 parts of melamine, and 6 parts of potassium chloride, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 50 parts of the fast-acting agent and 50 parts of the slow-acting agent, and press the agents under a pressure of 3 MPa respectively to form a fast-acting agent cartridge and a slow-acting agent cartridge; and
(5) Place the slow-acting agent cartridge in an agent pressing mold, drop the anhydrous ethanol on a surface of the slow-acting agent cartridge, then quickly place the fast-acting agent cartridge on top of the slow-acting agent cartridge, heat to 25° C., adjust the pressure to 9 MPa for pressing, and prepare a cylindrical fire-extinguishing agent with a diameter of Φ64 mm, where an amount of the anhydrous ethanol is 5% of a total cartridge mass of the fire-extinguishing agent, and a content of the anhydrous ethanol after pressing is less than 1%.

### Example 9

(1) Prepare a binder solution: add 10 parts of carboxymethyl cellulose to 5 parts of anhydrous ethanol for dissolution, and stir evenly to obtain a binder solution;
(2) Prepare a fast-acting agent: take 78 parts of potassium nitrate, 12 parts of melamine, and 1 part of tert-butylferrocene, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 78 parts of potassium nitrate, 12 parts of melamine, and 10 parts of potassium chloride, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 70 parts of the fast-acting agent and 30 parts of the slow-acting agent, and press the agents under a pressure of 3 MPa respectively to form a fast-acting agent cartridge and a slow-acting agent cartridge; and
(5) Place the slow-acting agent cartridge in an agent pressing mold, drop the anhydrous ethanol on a surface of the slow-acting agent cartridge, then quickly place the fast-acting agent cartridge on top of the slow-acting agent cartridge, heat to 25° C., adjust the pressure to 9 MPa for pressing, and prepare a cylindrical fire-extinguishing agent with a diameter of Φ64 mm, where an amount of the anhydrous ethanol is 5% of a total mass of the fire-extinguishing agent, and a content of the anhydrous ethanol after pressing is less than 1%.

### Example 10

(1) Prepare a binder solution: add 10 parts of carboxymethyl cellulose to 5 parts of anhydrous ethanol for dissolution, and stir evenly to obtain a binder solution;
(2) Prepare a fast-acting agent: take 78 parts of barium nitrate, 12 parts of melamine, and 1 part of tert-butylferrocene, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Prepare a slow-acting agent: take 78 parts of barium nitrate, 12 parts of melamine, and 10 parts of potassium chloride, sieve the raw materials respectively through a 100-mesh sieve and mix well, then add the binder solution and stir evenly, granulate through a 20-mesh standard sieve, and dry until the volatile content is less than 1% to obtain a slow-acting agent;
(4) Prepare cartridges: take 90 parts of the fast-acting agent and 10 parts of the slow-acting agent, and press the agents under a pressure of 3 MPa respectively to form a fast-acting agent cartridge and a slow-acting agent cartridge; and
(5) Place the slow-acting agent cartridge in an agent pressing mold, drop the anhydrous ethanol on a surface of the slow-acting agent cartridge, then quickly place the fast-acting agent cartridge on top of the slow-acting agent cartridge, heat to 25° C., adjust the pressure to 9 MPa for pressing, and prepare a cylindrical fire-extinguishing agent with a diameter of Φ64 mm, where an amount of the anhydrous ethanol is 5% of a total mass of the fire-extinguishing agent, and a content of the anhydrous ethanol after pressing is less than 1%.

### Comparative Example 1

(1) Prepare a binder solution: add 10 parts of carboxymethyl cellulose to 5 parts of anhydrous ethanol for dissolution, and stir evenly to obtain a binder solution;
(2) Prepare a fast-acting agent: take 78 parts of potassium nitrate, 12 parts of melamine, and 1 part of tert-butylferrocene, sieve the raw materials respectively through a 100-mesh sieve and mix well, then add the binder solution and stir evenly, granulate through a 20-mesh standard sieve, and dry until the volatile content is less than 1% to obtain a fast-acting agent;
(3) Pour the fast-acting agent into an agent pressing mold, and press the agent into a cylindrical fire-extinguishing agent with a diameter of Φ64 mm under a pressure of 9 MPa.

### Comparative Example 2

(1) Prepare a binder solution: add 10 parts of carboxymethyl cellulose to 5 parts of anhydrous ethanol for dissolution, and stir evenly to obtain a binder solution;
(2) Prepare a slow-acting agent: take 78 parts of potassium nitrate, 12 parts of melamine, and 10 parts of potassium chloride, sieve the raw materials respectively through a 100-mesh sieve and mix well, then add the binder solution and stir evenly, granulate through a 20-mesh standard sieve, and dry until the volatile content is less than 1% to obtain a slow-acting agent;
(3) Pour the slow-acting agent into an agent pressing mold, and press the agent into a cylindrical fire-extinguishing agent with a diameter of Φ64 mm under a pressure of 9 MPa.

Result verification: Fire-extinguishing agents prepared in Examples 1-10 and Comparative Examples 1-2 were loaded into apparatuses for fire-extinguishing experiments, which were conducted in accordance with an A-class wood stack fire test model specified in the standard ANSI/CAN/UL/ULC 2775:2019, with nozzles of the apparatuses facing a wood stack inside a protection cover. The results are shown in Table 1:

TABLE 1
Fire-extinguishing Concentration and Fire-extinguishing Time
of Fire-extinguishing Agents with Different Formulations

| | Content | | Fire- | |
|---|---|---|---|---|
| | of Fast- | Position of | extinguishing | Fire- |
| | acting | Fast-acting | Concentration | extinguishing |
| Item | Agent | Agent | (g/m³) | Time (s) |
| Example 1 | 90% | Upper part | 84 | 163 |
| Example 2 | 70% | Upper part | 84 | 160 |
| Example 3 | 50% | Upper part | 81 | 155 |
| Example 4 | 30% | Upper part | 81 | 158 |
| Example 5 | 10% | Upper part | 81 | 162 |
| Example 6 | 10% | Lower part | 81 | 188 |
| Example 7 | 30% | Lower part | 81 | 182 |
| Example 8 | 50% | Lower part | 81 | 178 |
| Example 9 | 70% | Lower part | 84 | 176 |
| Example 10 | 90% | Lower part | 84 | 176 |
| Comparative | 100% | — | 99 | 187 |
| Example 1 | | | | |
| Comparative | 0% | — | 96 | 196 |
| Example 2 | | | | |

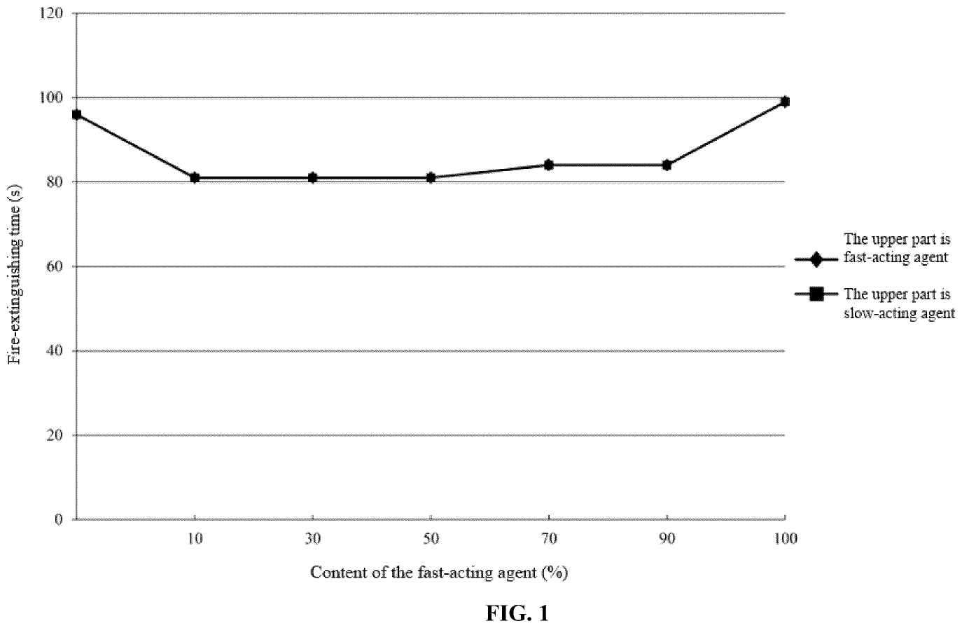

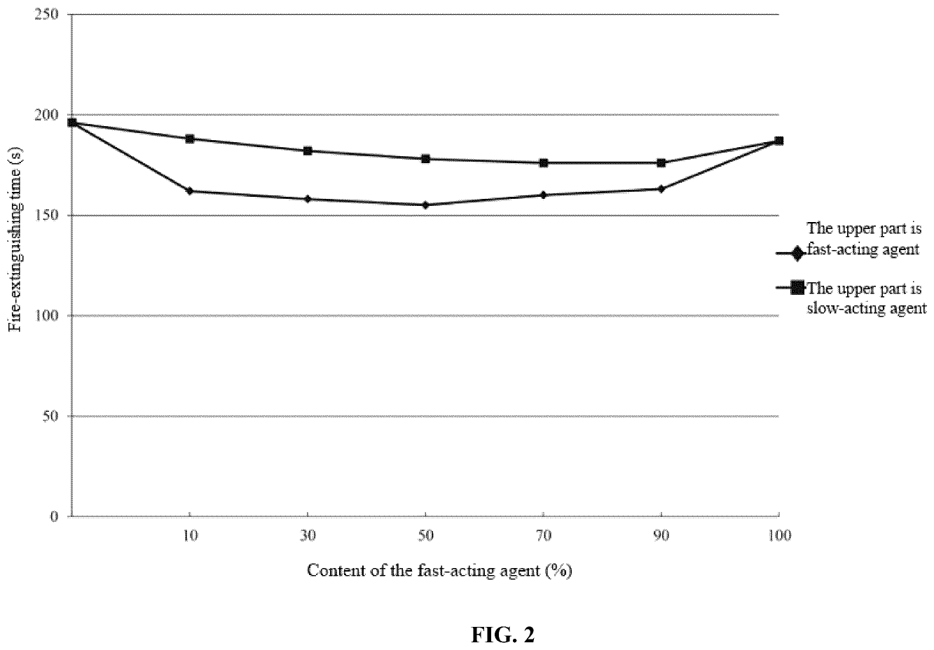

The results (Table 1, FIGS. 1-2) show that in the protected space, the fire-extinguishing agent prepared by combining the slow-acting agent and the fast-acting agent can keep the fire-extinguishing concentration below 85 g/m³. In Examples 1-5, the fast-acting agent is released first after the apparatus is activated, so that the fire-extinguishing time is maintained at about 160 seconds. When the slow-acting agent in Examples 6-10 and Comparative Example 2 is released first after the apparatus is activated, the fire-extinguishing time is maintained at about 180 seconds. In Comparative Example 1, only the fast-acting agent is used as the fire-extinguishing agent. Although the fire-extinguishing time is relatively short, the fire-extinguishing concentration is relatively high. In Comparative Example 2, only the slow-acting agent is used as the fire-extinguishing agent, resulting in both a longer fire-extinguishing time and a higher fire-extinguishing concentration. This indicates that the combined use of the slow-acting agent and the fast-acting agent can endow the fire-extinguishing agent with a dual fire-extinguishing mode, enabling the fire-extinguishing agent to have the advantages of low concentration and fast speed during fire extinguishing.

It can be seen from FIG. 2 that when an upper part of the combined fire-extinguishing agent is the fast-acting agent and a lower part is the slow-acting agent, the fire-extinguishing time is significantly shorter than when the upper part is the slow-acting agent and the lower part is the fast-acting agent. This is because when the fast-acting agent is in the upper part, the fast-acting agent can release a larger amount of fire-extinguishing agent in a short time, thereby quickly suppressing the fire. In addition, it is also found that the fire-extinguishing time of the combined fire-extinguishing agent is roughly inversely proportional to the content of the fast-acting agent therein, indicating that appropriately increasing the content of the fast-acting agent in the combined fire-extinguishing agent is beneficial to shortening the fire-extinguishing time.

### Comparative Example 3

Take 90 parts of the fast-acting agent and 10 parts of the slow-acting agent prepared in Example 10, and press the agents under a pressure of 3 MPa to form a fast-acting agent cartridge and a slow-acting agent cartridge respectively; and place the slow-acting agent cartridge in an agent pressing mold, place the fast-acting agent cartridge on top of the slow-acting agent cartridge, heat to 25° C., adjust the pressure to 9 MPa for pressing, and prepare a cylindrical fire-extinguishing agent with a diameter of Φ64 mm.

### Comparative Example 4

Take 90 parts of the fast-acting agent and 10 parts of the slow-acting agent prepared in Example 10, and press the agents under a pressure of 3 MPa to form a fast-acting agent cartridge and a slow-acting agent cartridge respectively; and place the slow-acting agent cartridge in an agent pressing mold, drop ultrapure water on a surface of the slow-acting agent cartridge, quickly place the fast-acting agent cartridge on top of the slow-acting agent cartridge, heat to 25° C., adjust the pressure to 9 MPa for pressing, and prepare a cylindrical fire-extinguishing agent with a diameter of Φ64 mm, where an amount of the ultrapure water is 5% of a total mass of the fire-extinguishing agent, and a content of the ultrapure water after pressing is less than 1%.

### Comparative Example 5

Take 90 parts of the fast-acting agent and 10 parts of the slow-acting agent prepared in Example 10, and press the agents under a pressure of 3 MPa to form a fast-acting agent cartridge and a slow-acting agent cartridge respectively; and place the slow-acting agent cartridge in an agent pressing mold, drop anhydrous ethanol onto a surface of the slow-acting agent cartridge, quickly place the fast-acting agent cartridge on top of the slow-acting agent cartridge, adjust the pressure to 9 MPa for pressing, and prepare a cylindrical fire-extinguishing agent with a diameter of Φ64 mm, where an amount of the anhydrous ethanol is 5% of a total mass of the fire-extinguishing agent.

### Result Verification

Take the combined fire-extinguishing agents prepared in Example 10, Comparative Example 3, and Comparative Example 4, store the agents at 105° C. for 7 days, then cool the agents to room temperature, observe the aging and cracking of the combined fire-extinguishing agents, and conduct fire-extinguishing experiments.

The results showed that after 7 days of storage, the combined fire-extinguishing agent prepared in Example 10 showed no cartridge cracking. The fire-extinguishing concentration was 82 g/m³, and the fire-extinguishing time was 178 seconds, which was not significantly different from data obtained in the fire-extinguishing experiments immediately after preparation. However, after 7 days of storage, the combined fire-extinguishing agent prepared in Comparative Example 3 exhibited cracks at the contact surface between the slow-acting agent and the fast-acting agent. During the fire-extinguishing experiments, a fire spurt occurred, resulting in a shortened discharge time of the fire-extinguishing agent, abnormal discharge of the apparatus, and detachment of an upper cover, which seriously affected the safety of the apparatus in use. However, after 7 days of storage, the combined fire-extinguishing agent prepared in Comparative Example 4 exhibited cracks at the contact surface between the slow-acting agent and the fast-acting agent, leading to abnormal discharge of the apparatus. The combined fire-extinguishing agent prepared in Comparative Example 5, after 7 days of storage, exhibited no fracture of the cartridges. However, the agent burned unevenly, resulting in a poor fire-extinguishing effect. After cutting open the contact surface between the slow-acting agent and the fast-acting agent, small air bubbles were found on the contact surface. This was caused by the volatilization of excess anhydrous ethanol after the cartridge preparation was completed.

What is claimed is:

1. A combined condensed aerosol fire-extinguishing agent, comprising a fast-acting fire-extinguishing agent and a slow-acting fire-extinguishing agent.

2. The combined condensed aerosol fire-extinguishing agent according to claim 1, wherein the fast-acting fire-extinguishing agent comprises 60-78 parts of an oxidizing agent, 10-30 parts of a reducing agent, 10-12 parts of a binder, and 0-10 parts of a catalyst; and the slow-acting fire-extinguishing agent comprises 60-78 parts of an oxidizing agent, 10-30 parts of a reducing agent, 10-12 parts of a binder, and 0-10 parts of a retardant.

3. The combined condensed aerosol fire-extinguishing agent according to claim 2, wherein the oxidizing agent is any one of potassium nitrate, sodium nitrate, strontium nitrate and barium nitrate; the reducing agent is any one of dicyandiamide, nitroguanidine, activated carbon and melamine; the binder is any one of phenolic resin and carboxymethyl cellulose; the catalyst is any one of copper oxide, iron oxide and tert-butylferrocene; and the retardant is any one of calcium carbonate, magnesium oxide and potassium chloride.

4. The combined condensed aerosol fire-extinguishing agent according to claim 1, wherein a mass ratio of the fast-acting fire-extinguishing agent to the slow-acting fire-extinguishing agent is 1-9:9-1.

5. A preparation method for a combined condensed aerosol fire-extinguishing agent, comprising the following steps:
(1) dissolving a binder in anhydrous ethanol and mixing well to obtain a binder solution;
(2) sieving an oxidizing agent, a reducing agent and a catalyst and mixing well, then adding the binder solution, and drying to obtain a fast-acting agent;
(3) sieving the oxidizing agent, the reducing agent and a retardant and mixing well, then adding the binder solution, and drying to obtain a slow-acting agent;
(4) pressing the fast-acting agent and the slow-acting agent into cartridges, respectively; and
(5) placing the slow-acting agent cartridge and the fast-acting agent cartridge successively into an agent pressing mold, dropwise adding the anhydrous ethanol between the two agents, and pressing while heating to obtain a fire-extinguishing agent.

6. The preparation method for the combined condensed aerosol fire-extinguishing agent according to claim 5, wherein in step (1), a mass of the anhydrous ethanol is 5-6% of a total mass of the fire-extinguishing agent.

7. The preparation method for the combined condensed aerosol fire-extinguishing agent according to claim 5, wherein in step (4), a pressing pressure is 3-4 MPa.

8. The preparation method for the combined condensed aerosol fire-extinguishing agent according to claim 5, wherein in step (5), a heating temperature is 25-30° C., and a pressing pressure is 8-10 MPa.

9. The preparation method for the combined condensed aerosol fire-extinguishing agent according to claim 5, wherein in step (5), a mass of the anhydrous ethanol is 2-8% of a total mass of the fire-extinguishing agent.
